(19) United States
(12) Patent Application Publication
(10) Pub. No.: US 2014/0003203 A1
(43) Pub. Date: Jan. 2, 2014

(54) MAINSPRING FOR A TIMEPIECE

(71) Applicant: Nivarox-FAR S.A., Le Locle (CH)

(72) Inventors: Christian CHARBON, Chezard-St-Martin (CH); Maxime Govaerts, Yverdon (CH); Cedric Von Gruenigen, Neuchatel (CH)

(21) Appl. No.: 13/924,855

(22) Filed: Jun. 24, 2013

(30) Foreign Application Priority Data
Jun. 28, 2012 (EP) 12174134.2

(51) Int. Cl. G04B 1/14

(52) U.S. Cl. CPC G04B 1/145
USPC 368/140; 29/896.9

(57) ABSTRACT

The invention relates to a mainspring (1) including a metal strip (3). According to the invention, the metal is austenitic steel (5) in order to limit sensitivity to magnetic fields and at least the outer surface of the strip (3) is hardened compared to the rest of the strip to a predetermined depth (7) in order to harden the strip (3) in the main areas of stress while maintaining a low modulus of elasticity.

This application claims priority from European Patent Application No. 12174134.2 filed Jun. 28, 2012, the entire disclosure of which is incorporated herein by reference.

### FIELD OF THE INVENTION

The invention relates to a mainspring for a timepiece and particularly a mainspring intended to be integrated in a barrel.

### BACKGROUND OF THE INVENTION

It is known to use Nivaflex 45/5 to form a mainspring for a barrel. This material offers a high limit of elasticity, typically 3100 MPa and a high modulus of elasticity, typically 220 GPa.

### SUMMARY OF THE INVENTION

It is an object of the invention to overcome all or part of the aforementioned drawbacks by proposing an alternative single-piece mainspring which both limits sensitivity to magnetic fields and provides a lower modulus of elasticity while having an improved limit of elasticity in the main areas of stress.

The invention therefore relates to a mainspring comprising a metal strip characterized in that the metal is austenitic steel so as to limit sensitivity to magnetic fields and in that at least the external surface of the strip is hardened compared to the rest of the strip to a predetermined depth in order to harden the strip in the main areas of stress while maintaining the low modulus of elasticity of the austenitic steel.

Consequently, a superficial area or the entire strip is hardened, i.e. the core of the strip may be barely modified or unmodified. This selective hardening of the strip means that the mainspring can combine advantages such as insensitivity to magnetic fields, a low modulus of elasticity and, in the main areas of stress, a high limit of elasticity, in addition to good resistance to corrosion and fatigue.

In accordance with other advantageous features of the invention:
the predetermined depth represents between 5% and 40% of the total thickness e of the strip;
the hardened outer surface includes diffused atoms of at least one non-metal such as nitrogen and/or carbon;
the hardened outer surface has a hardness of more than 1100 HV;
the hardened outer surface has a limit of elasticity of more than 3500 MPa.

Moreover, the invention relates to a barrel for a timepiece, characterized in that it includes a mainspring according to any of the preceding variants.

Finally, the invention relates to a method of manufacturing a mainspring including the following steps:
a) forming an austenitic steel based strip to limit sensitivity to magnetic fields;
b) diffusing atoms to a predetermined depth on the outer surface of the strip in order to harden the strip in the main areas of stress while maintaining a low modulus of elasticity.

Consequently, by diffusing atoms in the steel, a superficial layer is obtained where the entire strip is hardened without having to deposit a second material on top of the strip. Indeed, the hardening occurs within the material of the strip which, advantageously according to the invention, prevents any subsequent peeling off.

In accordance with other advantageous features of the invention:
the predetermined depth represents between 5% and 40% of the total thickness e of the strip;
the atoms include at least one non-metal such as nitrogen and/or carbon;
step b) consists of a thermochemical diffusion treatment;
step b) consists of a process of ion implantation and diffusion treatment;
the strip is wound in step a) or after step b).

### BRIEF DESCRIPTION OF THE DRAWINGS

Other features and advantages will appear clearly from the following description, given by way of non-limiting illustration, with reference to the annexed drawings, in which:

FIG. 1 is a diagram of a mainspring according to the invention.

FIG. 2 is a schematic cross-section of a mainspring according to the invention.

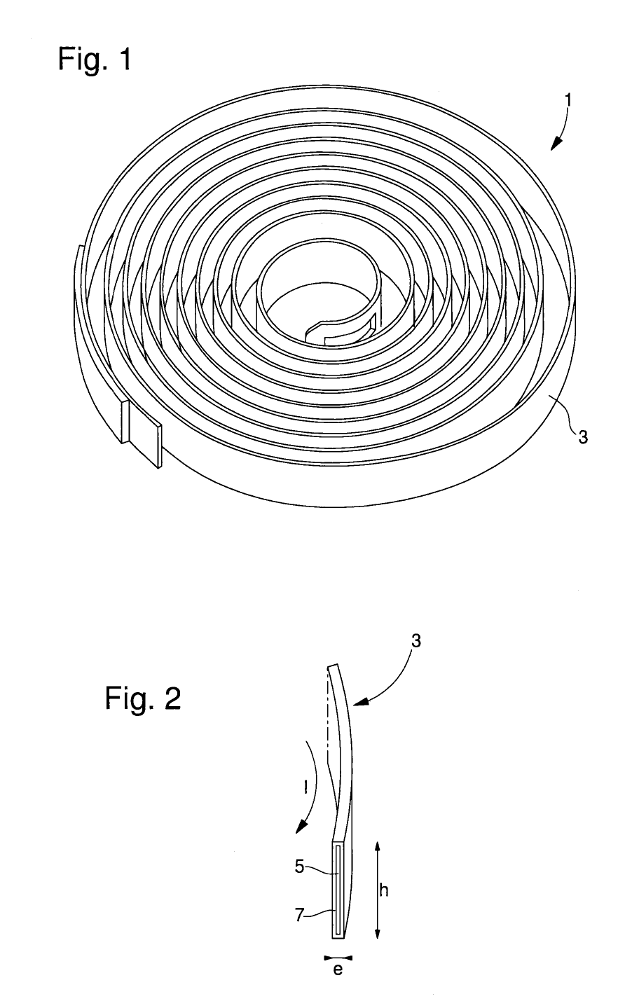

### DETAILED DESCRIPTION OF PREFERRED EMBODIMENTS

The invention relates to a mainspring such as for a timepiece barrel. Evidently, other applications requiring a mainspring may also be envisaged, such as for example an automaton.

Mainspring 1 according to the invention includes a metal strip 3 which is preferably wound around itself. During development and simulations, it was discovered that mainsprings of this type undergo stresses which are essentially applied to the outer surface of strip 3, i.e. on length l, height h and thickness e. Thus, the stresses decrease from the outer surface to the centre of strip 3 where the stresses are zero.

Consequently, it was discovered that, although it was important for strip 3 to have a high limit of elasticity, this value did not need to be homogeneous and it could be limited to a predetermined depth in the outer surface.

Moreover, with the magnetism induced by objects that are encountered on a daily basis, it is important to limit the sensitivity of mainsprings 1 to avoid affecting the working of the timepiece in which they are incorporated. However, a material with a high limit of elasticity is generally very sensitive to magnetic fields.

Surprisingly, the invention overcomes both problems at the same time with no compromise and provides additional advantages. Thus, metal 5 is an austenitic and, preferably stainless, steel to advantageously limit sensitivity to magnetic fields. Further, at least outer surface 7 of the strip is hardened compared to the rest of the strip to a predetermined depth so as to offer, advantageously according to the invention, a high limit of elasticity on said outer surface while maintaining the low modulus of elasticity of the austenitic steel.

Indeed, according to the invention, the limit of elasticity of the hardened outer surface 7 is between 3500 and 4500 MPa, whereas the modulus of elasticity remains substantially equal to or less than 190 GPa for a surface hardening of more than 1100 HV and advantageously comprised between 1200 HV and 2000 HV. The above values were obtained from 316L austenitic chromium-nickel stainless steel. Of course, other austenitic steels may be envisaged.

It has been empirically demonstrated that a hardening depth 7 of between 5% and 40% of the total thickness e of strip 3 is sufficient for application to a mainspring. By way of example, if the semi-thickness e/2 is 50 μm, the hardening depth is preferably around 15 μm into the entire perimeter strip 3 section. Evidently, depending upon the application, it is possible to provide a different hardening depth 7 of between 5% and 80% of the total thickness e.

Preferably according to the invention, the hardened outer surface 7 includes diffused atoms of at least one non-metal such as nitrogen and/or carbon. Indeed, as explained below, through interstitial saturation of atoms in steel 5, a superficial area 7 is hardened with no requirement to deposit a second material on top of strip 3. Indeed, hardening occurs within material 5 of strip 3 which, advantageously according to the invention, avoids any subsequent peeling off.

Consequently, at least one superficial area 7 is hardened, i.e. the core of strip 3 may remain barely modified or unmodified without any significant modification to the qualities of the mainspring. This selective hardening of strip 3 means that mainspring 1 can combine advantages, such as insensitivity to magnetic fields, low modulus of elasticity and, in the main areas of stress, a high limit of elasticity, while having good resistance to corrosion and fatigue.

The invention also relates to the method of manufacturing a mainspring as explained above. The method of the invention advantageously includes the following steps:
a) forming an austenitic steel based strip 3 to limit sensitivity to magnetic fields;
b) diffusing atoms at a predetermined depth in the outer surface of strip 3 so as to harden said strip in the main areas of stress.

According to a first preferred embodiment, strip 3 is wound in step a) to diffuse the atoms immediately into the final shape of mainspring 1.

However, according to a second preferred embodiment, strip 3 may also be wound after step b) in order to diffuse the atoms into an intermediate blank of mainspring 1.

Advantageously according to the invention, regardless of the embodiment, the method can be applied in bulk. Thus, step b) may consist of a thermochemical treatment such as cementing or nitriding several mainsprings and/or several mainspring blanks. It is clear that step b) may consist of the interstitial diffusion of non-metal atoms such as nitrogen and/or carbon in steel 5. Finally, advantageously, it was discovered that the compressive stresses of the method improve fatigue resistance.

Step b) could also consist of an ion implantation and diffusion treatment process. This variant has the advantage of not limiting the type of diffused atoms and of allowing both interstitial and substitutional diffusion.

Of course, this invention is not limited to the illustrated example but is capable of various variants and alterations that will appear to those skilled in the art. In particular, it is possible to envisage wholly or almost wholly treating strip 3, i.e. treating more than 80% of the thickness e of strip 3, although this is not necessary for application to a mainspring.

What is claimed is:

1. A mainspring comprising a metal strip, wherein the metal is austenitic steel in order to limit sensitivity to magnetic fields and in that at least the outer surface of the strip is hardened compared to the rest of the strip to a predetermined depth in order to harden the strip in the main areas of stress while maintaining the modulus of elasticity of austenitic steel.

2. The mainspring according to claim 1, wherein the predetermined depth represents between 5% and 40% of the total thickness of the strip.

3. The mainspring according to claim 1, wherein the hardened outer surface includes diffused atoms of at least one non-metal.

4. The mainspring according to claim 3, wherein said at least one non-metal is nitrogen and/or carbon.

5. The mainspring according to claim 1, wherein the hardened outer surface has a hardness of more than 1100 HV.

6. The mainspring according to claim 1, wherein the hardened outer surface has a modulus of elasticity of more than 3500 MPa.

7. A barrel for a timepiece wherein it includes a mainspring according to claim 1.

8. A method of fabricating a mainspring comprising the following steps:
a) forming an austenitic steel based strip to limit sensitivity to magnetic fields;
b) diffusing atoms to a predetermined depth on the outer surface of the strip in order to harden the strip in the main areas of stress while maintaining a low modulus of elasticity.

9. The method according to claim 8, wherein the predetermined depth represents between 5% and 40% of the total thickness of the strip.

10. The method according to claim 8, wherein the atoms include at least one non-metal.

11. The method according to claim 10, wherein said at least one non-metal is nitrogen and/or carbon.

12. The method according to claim 8, wherein step b) consists of a thermochemical diffusion treatment.

13. The method according to claim 8, wherein step b) consists of an ion implantation and diffusion treatment process.

14. The method according to claim 8, wherein the strip is wound in step a) or after step b).
